(19) United States
(12) Patent Application Publication
(10) Pub. No.: US 2014/0281581 A1
(43) Pub. Date: Sep. 18, 2014

(54) Storage Device

(71) Applicant: GENUSION, INC., Amagasaki (JP)

(72) Inventor: Yasushi KASA, Hyogo (JP)

(73) Assignee: GENUSION, INC., Amagasaki (JP)

(21) Appl. No.: 14/215,806

(22) Filed: Mar. 17, 2014

(30) Foreign Application Priority Data
Mar. 18, 2013 (JP) 2013055655
Dec. 12, 2013 (JP) 2013256859

(51) Int. Cl. G06F 21/62; G06F 17/30

(52) U.S. Cl. CPC G06F 21/6218; G06F 17/30091
USPC 713/190; 707/822

(57) ABSTRACT

A storage device includes a storage area and connected to a computer for causing a file system to operate. The file system causes a data area for storing contents of a plurality of files and a management area for managing the plurality of files to be secured in the storage area. The storage device includes the storage area; a file system monitor for detecting that the file system has performed an operation of erasing a file; and a controller for, when the file system monitor detects an operation of erasing the file, performing erasure or write to put an area corresponding to the erased file in the storage area into an unrecoverable state.

### CROSS-REFERENCE TO RELATED APPLICATIONS

This application is based upon and claims the benefit of priority to the prior Japanese Patent Application No. 2013-055655, filed on Mar. 18, 2013 and the prior Japanese Patent Application No. 2013-256859, filed on Dec. 12, 2013; the entire contents of which are incorporated herein by reference.

### FIELD

The present invention relates to a storage medium, and specifically, a storage device including a storage area and connected to a computer for causing a file system to operate, the file system causing a data area for storing contents of a plurality of files and a management area for managing the plurality of files to be secured in the storage area.

### BACKGROUND

A file system is software for managing and controlling a file, which is an assembly of data (information) having a variable size, such that the file is stored on a storage device such as a disk device (secondary storage device) or the like and is readable therefrom. In many cases, a file system is a component of an operating system.

A file system defines and stores, in a storage area of a storage device, a file name, size, attribute information such as date or the like, allocation information indicating what is to be stored in which area on a disk, and an area in which a main part of data is to be stored. The file system, which handles the attribute information, the allocation information and the main part of data, provides a disk device with an instruction to transfer or receive fixed-length data.

Throughout this specification, a behavior of a storage device as seen from a file system and an application using the file system will be referred to as Lv1 (level 1).

The storage device is not involved in the content or meaning of data. The storage device receives an instruction to transfer or receive fixed-length data via control software called a disk driver, and executes the instruction. Namely, the storage device merely performs write/read of data to/from a specified address area. Conventionally, the storage device does not detect an operation of deleting data performed on the file system.

Throughout this specification, an operation in the storage device will be referred to as Lv2 (level 2).

In the case where the storage device is a nonvolatile semiconductor storage device such as a flash memory or the like, the following is performed in the storage device. An interface device receives an instruction supplied from the file system, and a logical address included in the instruction is converted into a physical address. Thus, data is written in a data area specified by the physical address. Substantially the same operation is performed to read data. Namely, at Lv1, data write/read is performed in accordance with a logical address, whereas at Lv2, the logical address is converted into a physical address and data is written to, or read from, an area (block) specified by the physical address.

Conventionally, files created by a personal computer or the like are mainly stored on a USB memory or the like having a NAND flash memory. However, a USB memory or the like may be possibly lost. In the case where a file stored thereon includes sensitive information such as private information or the like or business secrets which need to be kept confidential strictly, a serious business loss may be incurred if such a USB memory is lost. In order to avoid such a loss, files are manually erased based on certain criteria, or software including an algorithm for erasing files at a certain timing is implemented on a personal computer.

For storing a file on a USB memory or the like having a NAND flash memory, a storage area is divided into a data area and a file management area. For deleting a file from a USB memory or the like having a NAND flash memory, the data in the file management area is rewritten so that it is merely considered that the corresponding file is “deleted”. This merely causes a situation where when the medium such as the USB memory or the like is formatted, the management area is erased and a start address of the file in the data area cannot be specified, which makes it difficult to read the file. In order to erase the file so as to be unrecoverable, fixed data such as FF or 00 needs to be written in the entire data area. Software for this purpose is known.

Conventionally, it has been proposed to improve the security by invalidating data containing confidential information by use of a device driver of a nonvolatile semiconductor storage device. However, it has been difficult to improve the security of a storage device because a structure of a file system in the storage device which cannot be known.

### SUMMARY

The present invention has an object of providing a storage device capable of erasing data with certainty in units of files although a structure of a file system in the storage device cannot be known.

The present invention is directed to a storage device including a storage area and connected to a computer for causing a file system to operate. The file system causes a data area for storing contents of a plurality of files and a management area for managing the plurality of files to be secured in the storage area. The storage device includes the storage area; a file system monitor for detecting that the file system has performed an operation of erasing a file; and a controller for, when the file system monitor detects an operation of erasing the file, performing erasure or write to put an area corresponding to the erased file in the storage area into an unrecoverable state.

In an embodiment of the present invention, the storage area includes a boot area; and the file system monitor acquires, from the boot area, an address of an area in which the management area is to be secured, and detects a change of data in the management area to detect that the file system has performed the operation of erasing the file.

In an embodiment of the present invention, the file system monitor creates a backup of the management area, compares the management area against the backup to detect whether or not the data in the management area has been changed, and determines whether or not the change of the data in the management area corresponds to erasure of the file.

In an embodiment of the present invention, the storage device according further includes a battery and a timer, wherein, when the timer detects an elapse of a predetermined time period, the controller performs erasure or write to put an area corresponding to the file into an unrecoverable state.

In an embodiment of the present invention, the storage device further includes an encryption/decryption device. The encryption/decryption encrypts a content of a file supplied from the file system, and the controller writes data obtained by the encryption to an area corresponding to the file; and the encryption/decryption decrypts data read from an area corresponding to a file, and the controller supplies the data obtained by the decryption to the file system.

The present invention is also directed to a storage device including a storage area and connected to a computer for causing a file system to operate. The file system causes a data area for storing contents of a plurality of files and a management area for managing the plurality of files to be secured in the storage area. The storage device includes the storage area; a logical address/physical address conversion table for storing information on conversion between a logical address by which the file system specifies a file and a physical address by which a controller specifies an area in the storage area; a file system monitor for detecting that the file system has performed an operation of erasing a file; and a controller for, when the file system monitor detects an operation of erasing the file, cancelling correspondence, stored in the logical address/physical address conversion table, between the logical address of data on the file and the physical address of the area corresponding to the erased file in the storage area.

In an embodiment of the present invention, immediately after the correspondence is cancelled, the controller performs erasure or write to put an area corresponding to the erased file in the storage area into an unrecoverable state.

In an embodiment of the present invention, after the correspondence is cancelled, at a time independent from the operation of erasing the file, the controller performs erasure or write to put an area corresponding to the erased file in the storage area into an unrecoverable state.

According to the present invention, a storage device capable of erasing data in units of files and preventing file leaks to a maximum possible degree is provided. The other effects of the present invention will be described below.

### BRIEF DESCRIPTION OF THE DRAWINGS

FIG. 1 is a block diagram showing a structure of a file system and a storage device in Example 1 according to the present invention;

FIG. 2 is a block diagram showing a structure of a file system and a storage device in Example 2 according to the present invention;

FIG. 3 is a structural view of a controller/file system unit;

FIG. 4 shows various processes performed in correspondence with commands;

FIG. 5 shows a memory map in which storage areas are mapped by logical addresses;

FIG. 6 shows a structure of a program to be executed by an MPU;

FIG. 7 is a flowchart showing a method for monitoring a FAT area;

FIG. 8 is a block diagram showing a structure of a file system and a storage device in Example 3 according to the present invention;

FIG. 9 is a block diagram showing a structure of a file system and a storage device in Example 4 according to the present invention;

FIG. 10 shows an example of logical address/physical address conversion table;

FIG. 11 is a flowchart showing a method for monitoring a FAT area in Example 5 according to the present invention; and

FIG. 12 is a flowchart showing a method for monitoring a FAT area in Example 6 according to the present invention.

### DETAILED DESCRIPTION OF EMBODIMENTS

Hereinafter, embodiments for carrying out the present invention will be described by way of examples. The present invention is not limited to the following embodiments, and the embodiments described below may be modified in various manners to carry out the present invention.

### Example 1

FIG. 1 is a block diagram showing a file system 11 and a storage device 13 (occasionally referred to as an “external disk”, “secondary storage device”, “data storage memory” or the like as opposed to a system acting as a host”) in Example 1 according to the present invention.

A computer (not shown) includes a CPU, a main memory, a display and a display interface, a keyboard and a keyboard interface, and the like. On the main memory, an operation system (OS) and application software (AS) are loaded. The OS includes a kernel part for managing execution of AS and controlling the display interface and the keyboard interface, and a user interface part. The OS and the AS are stored in a storage area 15 of the storage device 13, and are loaded on the main memory when the storage device 13 is turned on. A computer having such a structure is referred to as a “host”.

The OS includes the file system 11 in a part thereof. As described above, the file system 11 is software for managing and controlling a file, which is an assembly of data (information) having a variable size, such that the file is stored on a storage device such as a disk device (secondary storage device) or the like and is readable therefrom.

The file system 11 defines and stores, in a storage area of the storage device 13, a file name, size, attribute information such as date or the like, allocation information indicating what is to be stored in which area on a disk, and an area in which a main part of data is to be stored. The file system 11, which handles the attribute information, the allocation information and the main part of data, provides a disk device with an instruction to transfer or receive fixed-length data. Examples of the file system 11 are FAT, ext4 and the like.

A behavior of the storage device 13 as seen from the file system 11 and the AS using the file system 11 will be referred to as Lv1 (level 1).

The storage device 13 is not involved in the content or meaning of data. The storage device 13 receives an instruction to transfer or receive fixed-length data via a disk driver 12, which is control software, and executes the instruction.

The storage device 13 includes an interface 14, a storage area 15, a disk controller 17, and a file system monitor/complete erasure controller 16 provided by the present invention. Throughout this specification, an operation performed on the storage device 13 will be referred to as Lv2 (level 2). The storage device 13 may have any shape that an existing disk device can have, or may have a shape different from that of an existing disk device.

The storage area 15 may be a hard disk, a RAM, a phase change memory, a CD-R, a CD-RW, a DVD-RAM or the like. In the present invention, the storage area 15 is preferably a nonvolatile semiconductor storage device such as a flash memory or the like.

The interface 14 may be a USB interface used for a USB memory, an SD/MMC interface used for an SD card, or ATA or SCSI used for various disk drives.

The disk controller 17 mainly performs conversion between a logical address and a physical address. In the case where the storage area is a hard disk, when a logical address is acquired, the disk controller 17 converts the logical address to any of various physical addresses such as a head position, a cylinder address, a sector address and the like, and reads or writes data in accordance with the physical address. In the case where the storage area is a nonvolatile semiconductor storage device, when a logical address is acquired, the disk controller 17 converts the logical address to a physical address of a flash memory. On a nonvolatile semiconductor storage device, data cannot be written a great number of times. Therefore, change (update) of page data corresponding to a specific logical address is performed in the form of new write of data to a page corresponding to another physical address. Then, a process of equalizing the number of times of write to pages corresponding to a plurality of physical addresses is performed. This process is referred to as “wear leveling”. Furthermore, data on a page corresponding to a physical address that is not used anymore because the page data is changed (updated) is put into a usable state in the next cycle of operation. This process is referred to as “garbage collection”.

The file system monitor/complete erasure controller 16 is included in the storage device 13. Although belonging to Lv2, the file system monitor/complete erasure controller 16 analyzes and interprets the behavior of the file system belonging to Lv1, and detects file delete. Namely, the file system monitor/complete erasure controller 16 reads and interprets data in the storage area 15 to detect how the file system is structured, especially, to detect an area in the storage area 15 in which a management area for managing a plurality of files is present. The file system monitor/complete erasure controller 16 monitors the management area to determine that a target file has been deleted. Upon determining that the target file has been deleted, the file system monitor/complete erasure controller 16 specifies an area in the storage area 15 in which actual data is stored, and performs data erasure or data write to put the specified area into an unrecoverable state.

The disk controller 17 and the file system monitor/complete erasure controller 16 may be formed of the same semiconductor chip and installed as a control program operable by the same CPU.

In the case where the storage area 15 is a flash memory, data erasure is performed in units of blocks and data write is performed in units of pages, which are smaller than units of blocks. Once a block in which actual data on a file is erased, the file is put into an unrecoverable state. For deleting a file by writing data, the following is performed. In a page in which actual data on the file is stored, the same data or random data is written. Thus, the file is put into an unrecoverable state. In the case where the storage area 15 is a hard disk, a sector in which actual data corresponding to the file is stored is overwritten. Thus, the file is put into an unrecoverable state.

With the above-described structure, the storage device 13 can behave as if a file system was stored thereon and the position of data on the file can be specified. Then, at an appropriate timing, an area corresponding to the data on the file is put into unrecoverable state by data erasure or data write (complete erasure). Thus, the file can be completely deleted so that the file cannot be leaked.

The timing to completely delete the file may be defined by supplying a “complete delete command” explicitly from the host. Alternatively, according to the present invention, the storage device 13 monitors file attribute information and information on a file allocation table to detect a change. At the timing when the change detected, the data is completely erased.

### Example 2

With reference to FIG. 2 through FIG. 7, Example 2 according to the present invention will be described. Elements identical to those in Example 1 will bear identical reference signs thereto, and descriptions thereof will be omitted. In Example 2, the file system 2 is a FAT, and the storage area 15 is a nonvolatile semiconductor device. A controller/file system unit 18 has functions of logical address/physical address conversion, wear leveling, garbage collection, file system monitoring, complete erasure and the like.

The storage area 15 includes a plurality of flash memory chips 19. Each flash memory chip 19 includes a plurality of blocks, which is a unit to be erased at the same time. Each erasure block includes a plurality of pages, which is a unit to which data is written at the same time. One flash memory 19 includes, for example, four banks. One bank includes 16 blocks, one block includes 4096 pages, and one page includes 2 kbits, namely, 128 words.

As described above, the controller/file system unit 18 has functions of logical address/physical address conversion, wear leveling, garbage collection, file system monitoring, complete erasure and the like. The controller/file system unit 18 is realized by a combination of a microcontroller and an external memory, by an FPGA, by a custom logic or the like.

FIG. 3 is a block diagram of the controller/file system unit 18. The controller/file system unit 18 includes an input/output latch 21 connected to the interface 14, an input/output latch 22 connected to the storage area 15, an internal bus 26, an MPU 23, a program memory 24 for storing a code to be executed by the MPU 23, and a data memory 25 temporarily storing data which is being processed. In the data memory 25, a logical address/physical address conversion table is developed.

FIG. 4 shows various processes performed in correspondence with commands received via the interface 14. Upon receiving a read command (read), the controller/file system unit 18 interprets this command and performs logical address/physical address conversion (A1). Then, the controller/file system unit 18 instructs the flash memory 19, via the input/output latch 22, to perform a read operation from the physical address obtained by the conversion. Upon receiving a write command (write), the controller/file system unit 18 interprets this command and performs logical address/physical address conversion. When the target physical address is in use, another physical address in an unused area is re-allocated, the logical address/physical address conversion table is updated; whereas when the target physical address is not in use, the target physical address is used (A2). Then, the controller/file system unit 18 instructs the flash memory 19, via the input/output latch 22, to perform a program operation to the physical address obtained by the conversion. Upon receiving a delete command (delete), the controller/file system unit 18 interprets this command, and performs a process on the above data area so that the data is made unrecoverable, without performing re-allocation to an unused area. Then, the controller/file system unit 18 instructs the flash memory 19 to perform an erase operation or the program operation in an area of a physical address corresponding to the logical address. The program operation stores the same data or random data on all the bits, so that the data is made unrecoverable.

FIG. 5 shows a memory map 30, which shows a state of the storage area 15 mapped in accordance with logical addresses. In Example 2, the file system 11 is a FAT. In FAT, a management area 31 is defined and stored in a part of the storage area 15. In the management area 31, a file name, size, attribute information such as date or the like, and file allocation information (logical address) are stored. In the example shown in FIG. 5, data on file 1 and data on file 2 are respectively stored in data areas 32 and 33. In the management area 31, leading addresses of the data areas 32 and 33 (file pointers) are stored. In the FAT system, a boot area is predefined. In the boot area, which area is the FAT area is defined. Specifically, a leading address and the size of the FAT area are defined.

FIG. 6 shows a structure of a program 40 to be executed by the MPU 23. The program 40 is stored on the program memory 24. The program 40 includes a command processing unit 41, a logical address/physical address conversion unit 42, a read processing unit 43, a program processing unit 44, an erase processing unit 45, a file system monitor 46 and the like.

The command processing unit 41 is a group of programs for interpreting a read command, a write command and a delete command which are supplied via the interface 41 and the input/output latch 21.

The logical address/physical address conversion unit 42 is a group of programs for performing address conversion by use of a logical address/physical address conversion table developed in the data memory 25. Wear leveling and garbage collections are performed by use of the function of the logical address/physical address conversion unit 42.

The read processing unit 43, the program processing unit 44 and the erase processing unit 45 respectively issue, to the flash memory 19, a read command, a program command and an erase command for an area corresponding to a physical address obtained by the conversion, and stores data read from the flash memory 19 on the data memory 25.

The file system monitor 46 includes a FAT area detection unit 47, a FAT monitor 48 and an invalidation processing unit 49. The FAT area detection unit 47 is a program operable when the storage device 13 is turned on or operable in the background. The FAT area detection unit 47 reads data stored in the boot area to specify the FAT area. The FAT monitor 48 always keeps on monitoring accesses made to the specified FAT area, and detects whether or not there is a process performed when the FAT area is changed and a file is deleted by the file system. When the FAT monitor 48 detects that a file has been deleted, the invalidation processing unit 49 performs an invalidation process on a page in which read data on the deleted file was stored. The invalidation process is, specifically, a process of erasing a block in which read data on a file is stored to put the file into an unrecoverable state or a process of writing the same data or random data to a page in which the real data on a file is stored to put the file into an unrecoverable state.

FIG. 7 is a flowchart showing a method for monitoring a FAT area. In advance, the FAT area detection unit 47 specifies a FAT area and creates a backup 51 of the area. The backup may be developed in the storage area 15, but is preferably developed in the data memory 25. When the command processing unit 41 interprets a command and detects an access made to the FAT area, the FAT monitor 48 compares target data to which the access has been made against a corresponding part of the backup (step 52). When the value of the FAT area is changed from a non-zero value to zero (in the case of a FAT 16 file system, when zeroes are continuous for 2 bytes; in the case of a FAT 32 file system, when zeroes are continuous for 4 bytes), it is interpreted that the file has been deleted (step 53). When it is interpreted that the file has been deleted, the invalidation processing unit 49 performs an invalidation process on a real area of the file (step 54). Next, the backup 51 is updated to the post-change content (step 55). Steps 52 through 55 are repeated.

In Example 2, a FAT is used as the file system. Alternatively, NTFS, ext4 or the like may be used because such file systems have substantially the same management area. A process in conformity to the write procedure defined by ISO9660 or the like may be used.

### Example 3

FIG. 8 is a block diagram of a storage device in Example 3 according to the present invention. Elements identical to those in Examples 1 and 2 will bear identical reference signs thereto, and descriptions thereof will be omitted. The storage device in Example 3 includes a battery 61 and a timer 62 in addition to the elements of the storage device in Example 2. When the timer 62 detects an elapse of a predetermine time period, a controller performs data erasure from, or data write to, an area corresponding to a file such that the file is put into an unrecoverable state.

Owing to such a structure, failure to erase can be prevented effectively, so that leaks of confidential files can be prevented at a higher level.

### Example 4

FIG. 9 shows a storage device in Example 4 according to the present invention. Elements identical to those in Examples 1 and 2 will bear identical reference signs thereto, and descriptions thereof will be omitted. The storage device in Example 4 includes an encryption/decryption device 63 in addition to the elements of the storage device in Example 2. A content of a file supplied from the file system is encrypted by the encryption/decryption device 63, and the obtained data is written to an area corresponding to the file. Data read from an area corresponding to a file is decrypted by the encryption/decryption device 63, and the obtained data is supplied to the file system.

Owing to such a structure, leaks of files can be prevented at a higher level against an attempt to recover files by use of reverse engineering performed on a flash memory.

The structure of Example 3 and the structure of Example 4 may be combined together.

### Example 5

As described above, the disk controller 17 performs conversion between a logical address and a physical address. The disk controller 17 may also perform wear leveling or garbage collection. As described above, the controller/file system unit 18 has functions of logical address/physical address conversion, wear leveling, garbage collection, file system monitoring, complete erasure and the like.

FIG. 10 shows an example of logical address/physical address conversion table present in the disk controller 17 in Example 1 or in the controller/file system unit 18 in Example 2.

A logical address/physical address conversion table 70 in FIG. 10 shows the correspondence between logical addresses LA and physical addresses PA in the file system. Namely, logical addresses LA0 through n are in correspondence with the physical addresses PA0 through n, respectively. For example, logical address LA0 is initially in correspondence with physical address PA0. When data at logical address LA0 is written to new data (erased and written), new data is written to an area of physical address PA1 and the physical address corresponding to logical address LA0 is changed from PA0 to PA1.

The structure of the storage device in Example 5 is substantially the same as the structure described in Example 2 with reference to FIG. 2 through FIG. 6. The logical address/physical address conversion table 70 present in the controller/file system unit 18 in Example 5 is shown in FIG. 10. The logical address/physical address conversion table 70 includes, in addition to the areas of the logical addresses LA and the physical addresses PA, flag areas F which each indicate whether or not the correspondence between a logical address and a physical address has been canceled. When the correspondence is cancelled, a flag is set in the corresponding flag area F.

FIG. 11 is a flowchart showing a method for monitoring a FAT area in Example 5. In advance, the FAT area detection unit 47 specifies a FAT area and creates a backup 51 of the area. When the command processing unit 41 interprets a command and detects an access made to the FAT area, the FAT monitor 48 compares target data to which the access has been made against a corresponding part of the backup (step 52). When the value of the FAT area is changed from a non-zero value to zero (in the case of a FAT 16 file system, when zeroes are continuous for 2 bytes; in the case of a FAT 32 file system, when zeroes are continuous for 4 bytes), it is interpreted that the file has been deleted (step 53). When it is interpreted that the file has been deleted, a logical address/physical address conversion table correction unit 71 cancels logical address/physical address conversion. The “cancellation of logical address/physical address conversion” refers to elimination of the correspondence between a logical address and a physical address, namely, setting a flag in a flag area F in FIG. 10. The corresponding physical address in the physical address area may be replaced with an invalid physical address (value which cannot be present as a physical address). Immediately after this, an invalidation process is performed on a real area of the file (step 54). Then, the backup 51 is updated to the post-change content (step 55). Steps 52 through 55 are repeated.

The above-described structure provides the following effects.

When the correspondence between a logical address and a physical address is cancelled, the corresponding storage area cannot be read by specifying the logical address. This state is equivalent to a state where the data in the storage area is erased in a usual operation. If the flash memory itself is retrieved and data is accessed, the data can be read. Therefore, the data is not completely erased. However, this state is sufficient for general use, namely, is sufficient on the premise that the memory is not decomposed for investigation.

Immediately after the logical address/physical address correspondence is cancelled, the invalidation process described in Example 2 is performed (step 54). Therefore, substantially the same effect as provided by Examples 1 through 4 that the data can be erased in units of files with certainty is provided.

### Example 6

Example 6 is a modification of Example 5. In Example 5, immediately after the cancellation of logical address/physical address correspondence, the invalidation process is performed. In Example 6, independently from the cancellation of logical address/physical address correspondence, an invalidation process is performed in the background.

FIG. 12 is a flowchart showing a method for monitoring a FAT area in Example 6. In advance, the FAT area detection unit 47 specifies a FAT area and creates a backup 51 of the area. When the command processing unit 41 interprets a command and detects an access made to the FAT area, the FAT monitor 48 compares target data to which the access has been made against a corresponding part of the backup (step 52). When the value of the FAT area is changed from a non-zero value to zero (in the case of a FAT 16 file system, when zeroes are continuous for 2 bytes; in the case of a FAT 32 file system, when zeroes are continuous for 4 bytes), it is interpreted that the file has been deleted (step 53). When it is interpreted that the file has been deleted, the logical address/physical address conversion table correction unit 71 cancels logical address/physical address conversion. Then, the backup 51 is updated to the post-change content (step 55). Steps 52 through 55 are repeated.

Independently from the repetition of steps 52 through 55, the invalidation process described in Example 2 is performed in the background on a physical address at which the data has been erased.

The above-described structure provides the following effects in addition to the effect that the data can be erased with certainty in units of files.

In a conventional file system, only file management information is changed in order to erase a file. Therefore, the response as seen from a user is fast, and the user is accustomed to such a fast response. In Example 6, the logical address/physical address correspondence is canceled so that a specific block is treated as being erased. Therefore, the response as seen from the use is fast. Namely, in Example 6, the response speed to the file erasure is raised and also the speed of the process performed in the background is also raised (since data transfer is not needed for the invalidated area, the time for the data transfer can be saved).

What is claimed is:

1. A storage device including a storage area and connected to a computer for causing a file system to operate, the file system causing a data area for storing contents of a plurality of files and a management area for managing the plurality of files to be secured in the storage area, the storage device comprising:
the storage area;
a file system monitor for detecting that the file system has performed an operation of erasing a file; and
a controller for, when the file system monitor detects an operation of erasing the file, performing erasure or write to put an area corresponding to the erased file in the storage area into an unrecoverable state.

2. The storage device according to claim 1, wherein:
the storage area includes a boot area; and
the file system monitor acquires, from the boot area, an address of an area in which the management area is to be secured, and detects a change of data in the management area to detect that the file system has performed the operation of erasing the file.

3. The storage device according to claim 1, wherein the file system monitor creates a backup of the management area, compares the management area against the backup to detect whether or not the data in the management area has been changed, and determines whether or not the change of the data in the management area corresponds to erasure of the file.

4. The storage device according to claim 1, further comprising a timer, wherein, when the timer detects an elapse of a predetermined time period, the controller performs erasure or write to put an area corresponding to the file into an unrecoverable state.

5. The storage device according to claim 1, further comprising an encryption/decryption device, wherein:
the encryption/decryption encrypts a content of a file supplied from the file system, and the controller writes data obtained by the encryption to an area corresponding to the file; and
the encryption/decryption decrypts data read from an area corresponding to a file, and the controller supplies the data obtained by the decryption to the file system.

6. A storage device including a storage area and connected to a computer for causing a file system to operate, the file system causing a data area for storing contents of a plurality of files and a management area for managing the plurality of files to be secured in the storage area, the storage device comprising:
the storage area;
a logical address/physical address conversion table for storing information on conversion between a logical address by which the file system specifies a file and a physical address by which a controller specifies an area in the storage area;
a file system monitor for detecting that the file system has performed an operation of erasing a file; and
the controller for, when the file system monitor detects an operation of erasing the file, cancelling correspondence, stored in the logical address/physical address conversion table, between the logical address of data on the file and the physical address of the area corresponding to the erased file in the storage area.

7. The storage device according to claim 6, wherein after the correspondence is cancelled, the controller performs erasure or write to put an area corresponding to the erased file in the storage area into an unrecoverable state.

8. The storage device according to claim 6, wherein after the correspondence is cancelled, at a time independent from the operation of erasing the file, the controller performs erasure or write to put an area corresponding to the erased file in the storage area into an unrecoverable state.
